(19) United States
(12) Patent Application Publication
(10) Pub. No.: US 2013/0078493 A1
(43) Pub. Date: Mar. 28, 2013

(54) BATTERY DEVICE WITH CONFINING STRUCTURE INSIDE

(71) Applicant: Ming-Lung CHEN, Hsin-Chu (TW)

(72) Inventor: Ming-Lung CHEN, Hsin-Chu (TW)

(73) Assignee: AU OPTRONICS CORP., Hsin-Chu (TW)

(21) Appl. No.: 13/400,822

(22) Filed: Feb. 21, 2012

(30) Foreign Application Priority Data
Sep. 27, 2011 (TW) 100134888

(51) Int. Cl. H01M 2/10

(52) U.S. Cl. 429/96

(57) ABSTRACT

A battery device includes a battery cell having a positive electrode, a negative electrode, a separator interposed therebetween and a confining structure for confining the battery cell. The confining structure includes a first confining member and a second confining member so that parts of the first confining member and parts of the second confining members contact with the battery cell at different positions.

### TECHNICAL FIELD

The present invention relates to a confining structure which exerts a sustaining force on a battery cell and more particularly to a pouch type battery device having the confining structure therein.

### BACKGROUND

A rechargeable battery is essential to a portable device. A rechargeable battery generally includes a battery cell and electrolyte solution or polymer electrolyte sealed in an external package. The electrolyte solution is generally a mixture (solution) of lithium salt and a carbonate-based organic solvent. Recently, polymer electrolyte is also popular for a rechargeable battery. A battery cell includes a positive electrode, a negative electrode and a separator which is disposed between the electrodes so as to prevent from short circuit occurring between the positive and negative electrodes. Conventional battery cells may be classified into stack type battery cells and jelly-roll type battery cells according to the battery cell structures. For a stack type battery cell, positive and negative electrodes are piled up and a separator is disposed between the electrodes for electrical insulation. The stack type battery cell is enclosed in the external package together with the electrolyte so that a battery device is completed. The external package of the stack type battery cell may be an aluminum foil package, a pouch or a metallic shell. For a jelly-roll type battery cell, at first, a positive electrode, a separator and a negative electrode are laminated in sequence, and then rolled up as a cylinder. Then the jelly-roll battery cell is enclosed in the external package to complete the battery device. Likewise, the external package of the jelly-roll battery cell may be an aluminum foil package, a pouch or a metallic shell.

A battery cell, either stack type or jelly-roll type, would inflate due to the gas generated during or after the cell formation. Herein and hereafter, the term “cell formation” means the first charging of the battery cell after the battery device is produced. The lifetime and efficiency of a battery device would decrease because of the inflation of battery cell.

A battery device with an aluminum foil package or a pouch is called a pouch type battery. A pouch type battery is generally safer than the one with a metallic shell. Therefore, it is widely used in a portable device. However, it still has drawbacks. The external package of a pouch type battery provides poor confining capability to its battery cell, especially when gas is generated during charging/discharging period. The battery cell inflation occurs not only after the cell formation but also during every charging/discharging period. Therefore, each charging leads to further inflation of the battery cell. Eventually the efficiency and lifetime of the cell would be adversely affected.

A battery device with a metallic shell is at the risk of explosion. Although a battery device with a metallic shell encounters less problem of inflation compared to that with a soft package, once short circuit is caused by lithium precipitation during charging, and meanwhile the operation of safety vents fails, a large amount of released gas and energy would still lead to explosion.

### SUMMARY

An exemplary embodiment of the present invention provides a safe battery device with long lifetime, especially a pouch type battery device.

According to an embodiment of the present invention, a battery device is provided that includes a battery cell and a confining structure and the battery cell includes a positive electrode, a negative electrode, and a separator. The separator is disposed between the positive electrode and the negative electrode. The confining structure includes a first confining member and a second confining member. The battery cell is disposed between the first and the second confining members so that parts of the first confining member and parts of the second confining members contact with the battery cell at different positions.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1A is a schematic diagram illustrating a typical stack-type battery cell;

FIG. 1B is a schematic diagram illustrating a typical jelly-roll-type battery cell;

FIG. 2 is a schematic plane view illustrating a battery cell in FIG 1A or 1B enclosed with an external package;

FIG. 3A is a schematic diagram illustrating a battery cell and a confining structure included in a battery device, before assembling, according to a first embodiment of the present invention;

FIG. 3B is a schematic diagram illustrating an assembly of the battery cell and the confining structure as shown in FIG. 3A;

FIG. 4A is a schematic diagram illustrating a battery cell and a confining structure included in a battery device, before assembling, according to a second embodiment of the present invention; and

FIG. 4B is a schematic diagram illustrating an assembly of the battery cell and the confining structure as shown in FIG. 4A.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

A typical stack-type battery cell. The stack-type battery cell 10 comprises a positive electrode set including one or more positive electrodes 1, a negative electrode set including one or more negative electrodes 2, a positive electrode lead 4, a negative electrode lead 5 and a separator set including one or more separators 3. The separator 3 is disposed between the positive and negative electrodes so as to prevent from short circuit occurring between the electrodes. The positive electrode set, separator set and negative electrode set are interposed sequentially to complete a battery cell 10. Optionally, the battery cell 10 could be enclosed with an additional separator material.

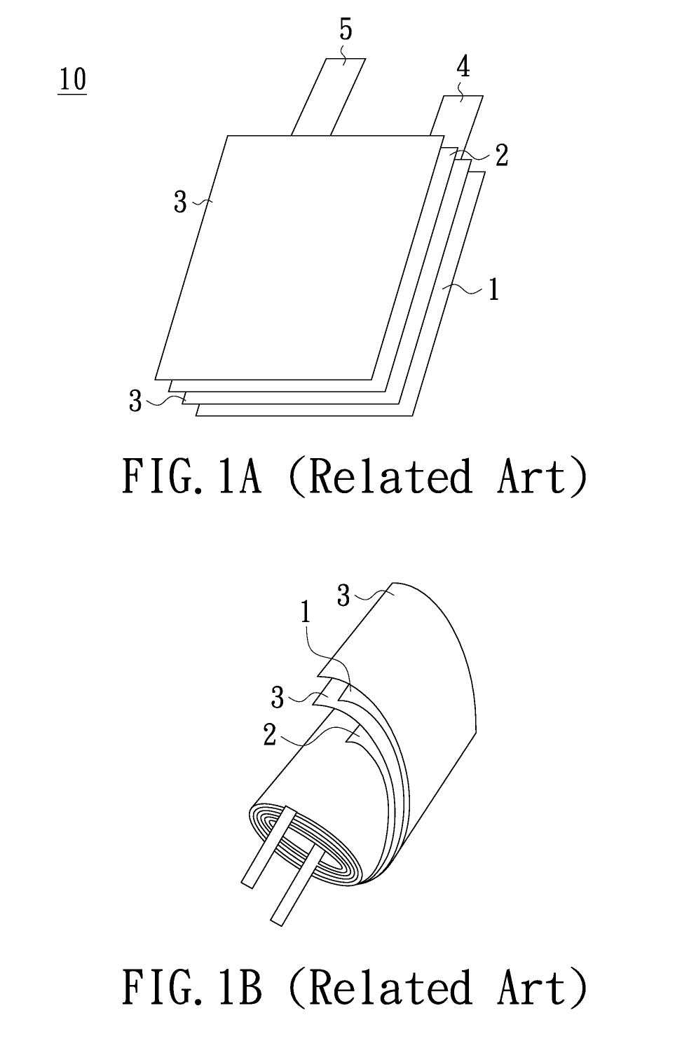

Another type of battery cell is so-called as a jelly-roll type, and a unit assembly thereof is as illustrated in FIG. 1B. In the assembly, a positive electrode 1, a separator 3 and a negative electrode 2 are laminated in sequence, and then rolled up as a cylinder. Optionally, another separator 3 may be further disposed as shown. Then the jelly-roll battery cell is enclosed with an external package (not shown in this figure) to complete the battery device.

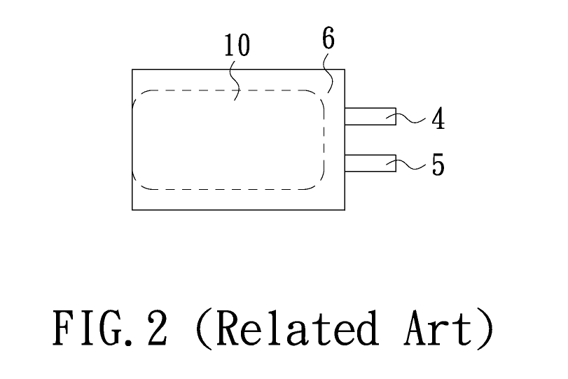

FIG. 2 schematically illustrates a battery cell 10 as shown in FIG. 1A or 1B wrapped with an external package 6. The external package 6 may be a pouch, aluminum foil package or a metallic shell.

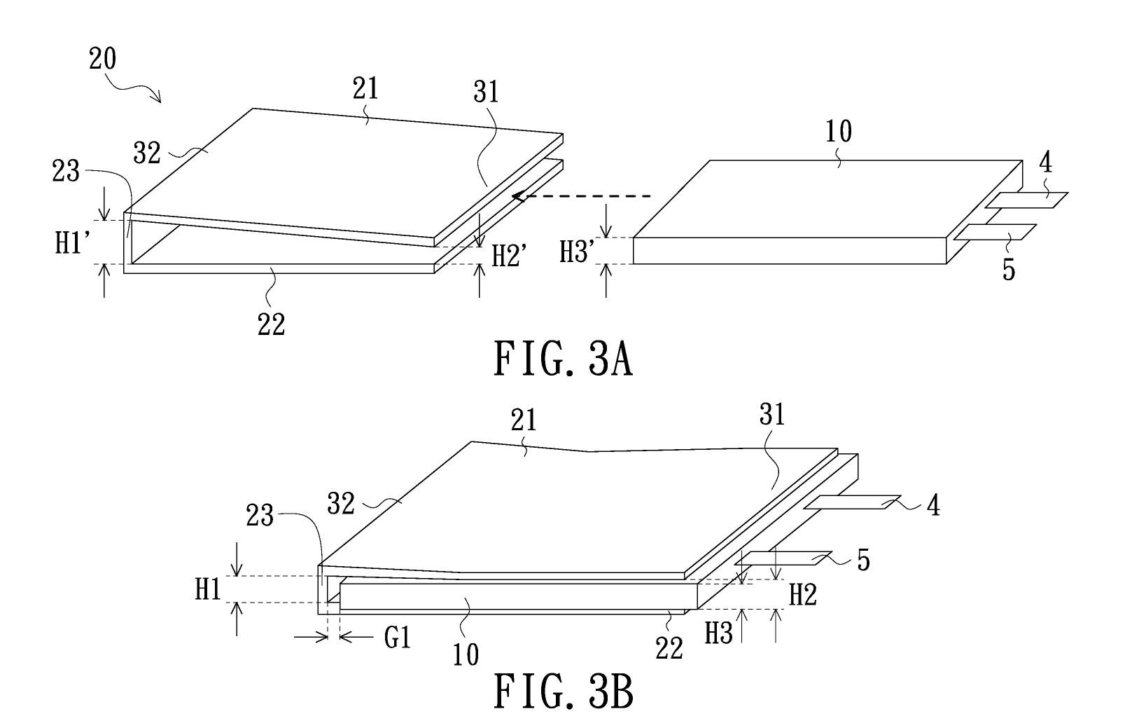

FIG. 3A is a schematic diagram illustrating a battery cell and a confining structure included in a battery device according to a first embodiment of the present invention. FIG. 3B schematically shows an assembly of the battery cell and the confining structure.

Referring to FIG. 3A and FIG. 3B, a battery device according to the first embodiment of the present invention comprises a battery cell 10, a confining structure 20 and an external package (not shown). The confining structure 20 comprises a first confining member 21, a second confining member 22 and a connecting member 23 which connects the first confining member 21 and the second confining member 22. In a preferred embodiment, the first confining member 21 and the second confining member 22 are disposed opposite to each other. Then the battery cell 10 is confined by the first confining member 21 and the second confining member 22 in a manner as shown in FIG. 3B, so that the first confining member 21 and the second confining member 22 contact with the battery cell 10 at different positions while pressing against the battery cell 10 in different directions. Accordingly, the confining structure 20 exerts a sustaining force against the battery cell 10 and limits the inflation of the battery cell 10. The efficiency and the lifetime of the battery device would not be adversely affected by the inflation of the battery cell 10. According to an embodiment of the present invention, the confining structure 20 may be applied to a pouch-type battery device or a battery device having a metallic shell, but the application is not limited to these two types.

As shown in FIG. 3B, the battery cell 10 is disposed between the first confining member 21 and the second confining member 22 of the confining structure 20. After cell formation or during a charging period, the battery cell 10 is likely to inflate so that the area of the first confining member 21 and the area of the second confining member 22 in contact with the battery cell 10 are increased. Accordingly, the confining structure 20 exerts an enhanced sustaining force on the battery cell 10 so as to limit the inflation of the battery cell 10.

After cell formation and during every charging/discharging period, the configuration of the first confining member 21 and the second confining member 22 may vary, depending on practical designs. For example, they may be parallel or non-parallel to each other, or combined to form a predetermined configuration. By exerting a sustaining force on the battery cell 10, gas generated during charging is squeezed out of the central portion of the battery cell toward peripheral regions of the battery cell 10, so as to solve the problems caused by the gas existing between electrodes and separators.

Referring again to FIG. 3A and FIG. 3B, the configuration of the confining structure 20 is described in detail in the following embodiment. Before cell formation, it is assumed the thickness of the battery cell 10 is H3′. After cell formation, the battery cell 10 inflates and its thickness becomes H3, wherein H3 is greater than H3′.

On the other hand, before cell formation, the interval between the first confining member 21 and the second confining member 22 is defined as H2′ at a first end 31 distant from the connecting member 23, and the interval between the first confining member 21 and the second confining member 22 at a second end 32 close to the connecting member 23 is defined as H1′, wherein H1′≧H2′, and the minimum interval between the first confining member 21 and the second confining member 22 is H2′. In the embodiment illustrated in FIG. 3A, H1′ is greater than H3′ while H2′ is a little less than or substantially equal to H3′ so that the battery cell can be put into and clamped by the confining structure 20.

After cell formation, as illustrated in FIG. 3B, since the battery cell 10 inflates and has the thickness of H3, the interval between the first confining member 21 and the second confining member 22 at the first end 31 becomes H2, which is greater than H2′, and the interval between the first confining member 21 and the second confining member 22 at the second end 32 becomes H1, which is greater than H1′. Furthermore, the formula, H3≦H2≦H1, stands. On the other hand, the connecting member 23 may contact with the battery cell 10, or not. It is preferred that there is a gap G1 between the connecting member 23 and the battery cell 10 for accommodating gas squeezed out of the battery cell 10 during the charging period. Preferably, the gap G1 ranges from 0 mm to 10 mm.

According to an embodiment of the present invention, the confining structure 20 is made of an insulating material or a metal core which is fully enclosed with an insulating material. The insulating material may be synthetic polymer, fluoropolymer, polyimide, or the like. Besides, in order to enhance the strength, flame-resistance and thermal conductance of the confining structure 20, the insulating material may further comprise ceramic particles or glass fibers. Examples of ceramic particles are Alumina(Al₂O₃), silica, BaTiO₃, ZrO₂ and TiO₂.

According to an embodiment of the present invention, the first confining member 21, the second confining member 22 and the connecting member 23 are produced separately and then assembled to form the confining structure 20. Alternately, the confining structure 20 may be integrally formed by injection molding or other ways alike. If the first confining member 21, the second confining member 22 or the connecting member 23 is produced separately, each could be made of insulating material or a metal core which is fully enclosed with an insulating material.

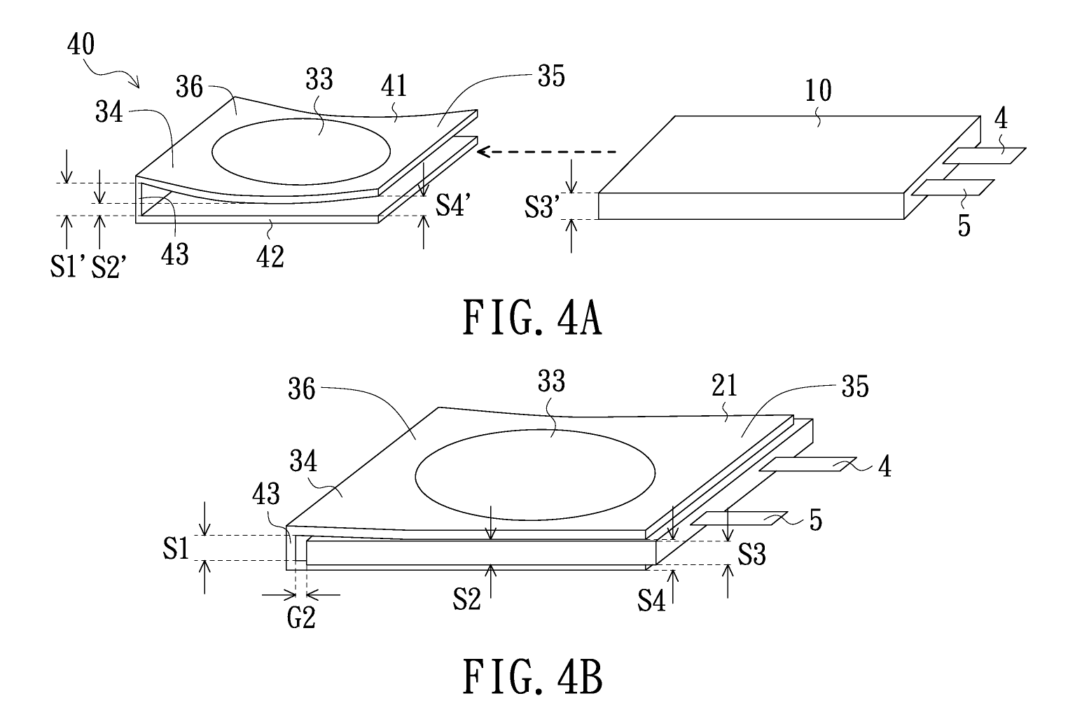

FIG. 4A and FIG. 4B show a second embodiment of an unpacked battery device according to the present invention. A confining structure 40 comprises a first confining member 41, a second confining member 42 and a connecting member 43 which connects the first confining member 41 and the second confining member 42. The first confining member 41 and the second confining member 42 contact with the battery cell 10 at different positions while pressing against the battery cell 10 in different directions. Then the battery cell 10 is confined by the first confining member 41 and the second confining member 42 in a manner as shown in FIG. 4B. Accordingly, the confining structure 40 exerts a sustaining force against the battery cell 10 and limits the inflation of the battery cell 10.

Referring again to FIG. 4A and FIG. 4B, the configuration of the confining structure is described in detail in the following embodiment. Before cell formation, it is assumed the thickness of the battery cell 10 is S3′. After cell formation, the battery cell 10 inflates and its thickness becomes S3, wherein S3 is greater than S3′.

On the other hand, before cell formation, the interval between the first confining member 41 and the second confining member 42 is defined as S4′ at a third end 35 distant from the connecting member 43, and the interval between the first confining member 41 and the second confining member 42 at a fourth end 36 close to the connecting member 43 is defined as S1′, and the interval between the first confining member 41 and the second confining member 42 at the central portion 33 of the confining structure is defined as S2′, and the minimum interval between the first confining member 41 and the second confining member 42 is S2′. In the embodiment illustrated in FIG. 4A and 4B, S1′ and S4′ are slightly greater than S3′ while S2′ is a little less than or substantially equal to S3′, so that the battery cell can be put into and clamped by the confining structure 40.

After cell formation, as illustrated in FIG. 4B, since the battery cell 10 inflates and has the thickness of S3, the interval between the first confining member 41 and the second confining member 42 at the third end 35 becomes S4, which is greater than S4′, and the interval between the first confining member 41 and the second confining member 42 at the fourth end 36 becomes S1, which is greater than S1′. Furthermore, both formulas, S3≦S4 and S3≦S1, stand. On the other hand, the connecting member 43 may contact with the battery cell 10, or not. It is preferred that there is a gap G2 between the connecting member 43 and the battery cell 10 for accommodating gas squeezed out of the battery cell 10 during the charging period. Preferably, the gap G2 ranges from 0 mm to 10 mm.

According to this embodiment of the present invention, the material of the confining structure 40 is the same as the ones described in the first embodiment. To find the details, please refer to the first embodiment.

According to the above-described embodiments of the present invention, a battery cell is disposed in a confining structure and enclosed with an external package to complete the assembling. The confining structure exerts a sustaining force on the battery cell during cell formation and a charging period so as to limit the inflation of the battery cell. Accordingly, gas generated after the cell information and during the charging period is squeezed out and exhausted to the peripheral regions of the battery cell. Therefore, the efficiency and the lifetime of the battery device would not be adversely affected by the inflation of the battery cell.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A battery device, comprising:
a battery cell, comprising:
a positive electrode;
a negative electrode; and
a separator disposed between the positive electrode and the negative electrode; and
a confining structure comprising a first confining member and a second confining member for confining the battery cell therebetween, wherein the first confining member and the second confining member partially contact with the battery cell, respectively.

2. The battery device according to claim 1, further comprising a pouch for wrapping the battery cell and the confining structure therein.

3. The battery device according to claim 1, wherein the confining structure further comprises a connecting member for connecting the first confining member and the second confining member.

4. The battery device according to claim 3, wherein there is a gap existing between the connecting member and the battery cell.

5. The battery device according to claim 3, wherein the confining member is made of an insulating material.

6. The battery device according to claim 5, wherein the confining structure is integrally formed by injection molding and the insulating material is a synthetic polymer.

7. The battery device according to claim 5, wherein the confining structure is integrally formed by injection molding and the insulating material is fluoropolymer or polyimide.

8. The battery device according to claim 5, wherein the insulating material comprises a ceramic particle or a glass fiber.

9. The battery device according to claim 3, wherein the confining structure is integrally formed by injection molding of an insulating material onto the entire surface of a metal core.

10. The battery device according to claim 9, wherein the insulating material is a synthetic polymer.

11. The battery device according to claim 9, wherein the insulating material is fluoropolymer or polyimide.

12. The battery device according to claim 9, wherein the insulating material comprises a ceramic particle or a glass fiber.

13. The battery device according to claim 3, wherein the first confining member and the second confining member comprise a metal core entirely enclosed with an insulating material.

14. The battery device according to claim 13, wherein the insulating material is a synthetic polymer.

15. The battery device according to claim 13, wherein the insulating material is fluoropolymer or polyimide.

16. The battery device according to claim 13, wherein the insulating material comprises a ceramic particle or a glass fiber.

17. The battery device according to claim 3, wherein the first confining member and the second confining member are disposed substantially in parallel to each other.

18. The battery device according to claim 3, wherein the maximum interval between the first confining member and the second confining member is located at a first end of the confining structure, close to the connecting member, and the minimum interval between the first confining member and the second confining member is located at a second end of the confining structure, distant from the connecting member.

19. The battery device according to claim 3, wherein the minimum interval between the first confining member and the second confining member is located at a central portion of the confining structure.
